(19) United States
(12) Patent Application Publication
(10) Pub. No.: US 2024/0305907 A1
(43) Pub. Date: Sep. 12, 2024

(54) DISTANCE IMAGE ACQUISITION DEVICE AND DISTANCE IMAGE ACQUISITION METHOD

(71) Applicant: HAMAMATSU PHOTONICS K.K., Hamamatsu-shi, Shzuoka (JP)

(72) Inventors: Keisuke UCHIDA, Hamamatsu-shi, Shizuoka (JP); Munenori TAKUMI, Hamamatsu-shi, Shizuoka (JP); Hisayoshi TAKAMOTO, Hamamatsu-shi, Shizuoka (JP); Naoaki KATO, Hamamatsu-shi, Shizuoka (JP); Katsuhiro NAKAMOTO, Hamamatsu-shi, Shizuoka (JP); Mitsuhito MASE, Hamamatsu-shi, Shizuoka (JP)

(73) Assignee: HAMAMATSU PHOTONICS K.K., Hamamatsu-shi, Shizuoka (JP)

(21) Appl. No.: 18/272,611

(22) PCT Filed: Jan. 13, 2022
(86) PCT No.: PCT/JP2022/000951

§ 371 Date: Jul. 17, 2023

(30) Foreign Application Priority Data
Mar. 1, 2021 (JP) 2021-031803

(51) Int. Cl. H04N 25/705; G01S 7/4863; G01S 7/4865; H04N 25/771

(52) U.S. Cl. CPC H04N 25/705; G01S 7/4863; G01S 7/4865; H04N 25/771

(57) ABSTRACT

A distance image acquisition apparatus includes a light source, an irradiation optical system, an imaging optical system, an imaging element, and a processing unit. The imaging element receives a light pulse output from the light source, reflected by an object, and passed through the imaging optical system on a light receiving surface. Each of a plurality of pixels on the light receiving surface includes a photodiode for generating charges by receiving light, and a charge accumulation portion for accumulating the charges generated in the photodiode. The processing unit commonly applies a control pattern to the plurality of pixels. The control pattern indicates a period in which the charges generated in the photodiode are accumulated in the charge accumulation portion. The processing unit acquires a distance image of the object based on an amount of charges generated in the photodiode and accumulated in the charge accumulation portion.

### TECHNICAL FIELD

The present disclosure relates to an apparatus and a method for acquiring a distance image of an object by a time-of-flight method.

### BACKGROUND ART

In a distance image acquisition apparatus using a time-of-flight (TOF) method, a distance image of an object can be acquired by forming an image of the object on a light receiving surface of an imaging element by receiving a light pulse with which the object is irradiated and reflected by the object, and acquiring a time until the light pulse output from a light source is reflected by the object and returns to the imaging element for each of a plurality of pixels on the light receiving surface.

A distance image acquisition apparatus of an invention disclosed in Patent Document 1 uses a compressive sensing technique when acquiring the distance image of the object by the TOF method. In this apparatus, a plurality of pixels each including a photodiode are arrayed two-dimensionally on a light receiving surface of an imaging element, and the plurality of pixels are divided into a plurality of groups, and further, different control patterns are applied to the pixels according to the groups.

In each pixel, charges generated in the photodiode in a period indicated by the applied control pattern are accumulated in a charge accumulation portion. Further, based on the control pattern applied to each pixel and an amount of charges accumulated in the charge accumulation portion in each pixel, analysis by the compressive sensing technique is performed to acquire the distance image of the object.

In the invention disclosed in Patent Document 1, the plurality of pixels on the light receiving surface of the imaging element are divided into the plurality of groups, and the different control patterns are applied to the pixels according to the groups, and thus, data necessary for performing the analysis by the compressive sensing technique can be obtained in a short time. Therefore, in the above invention, the distance image with high temporal resolution is obtained.

### CITATION LIST

### Patent Literature

Patent Document 1: Japanese Patent Publication No. 6666620
Patent Document 2: Japanese Patent Application Laid-Open Publication No. 2011-133464

### Non Patent Literature

Non Patent Document 1: Catalog of Distance area image sensor S11963-01CR, HAMAMATSU PHOTONICS K.K., August 2020

### SUMMARY OF INVENTION

### Technical Problem

According to the invention disclosed in Patent Document 1, the distance image with high temporal resolution can be obtained, however, there are the following problems. In the invention disclosed in Patent Document 1, the plurality of pixels on the light receiving surface of the imaging element are divided into the plurality of groups, and thus, the number of pixels included in each group is reduced and spatial resolution is decreased.

Depending on the arrangement relationship of the pixels included in each group on the light receiving surface of the imaging element, it is necessary to provide a lens for imaging for each group, which results in an increase in cost, and it is necessary to correct different parallaxes between groups, which results in complicated processing. Further, the different control patterns are applied to the pixels depending on the groups, and thus, it is necessary to prepare the same number of control patterns as the number of groups, and a configuration for the above becomes complicated.

An object of an embodiment is to provide an apparatus and a method capable of easily acquiring a distance image with high spatial resolution by the compressive sensing technique.

### Solution to Problem

An embodiment is a distance image acquisition apparatus. The distance image acquisition apparatus is an apparatus for acquiring a distance image of an object by a time-of-flight method, and includes (1) a light source for irradiating an object with a light pulse; (2) an imaging optical system for inputting and forming an image of the light pulse with which the object is irradiated from the light source and reflected by the object; (3) an imaging element including a plurality of pixels each including a photodiode and arrayed on a light receiving surface for receiving the light pulse passed through the imaging optical system; and (4) a processing unit for commonly applying, to the plurality of pixels, a control pattern in which a first logical value and a second logical value appear alternately in time from a light pulse output timing of the light source, and acquiring a distance image of the object based on charges generated in the photodiode of each of the plurality of pixels, and each of the plurality of pixels includes a first charge accumulation portion for accumulating the charges generated in the photodiode in a period in which the control pattern has the first logical value, and the processing unit acquires, for each of the plurality of pixels, a distance to the object by a compressive sensing technique based on an amount of charges accumulated in the first charge accumulation portion when the control pattern is set to each of a plurality of control patterns.

An embodiment is a distance image acquisition method. The distance image acquisition method is a method for acquiring a distance image of an object by a time-of-flight method, and uses (1) a light source for irradiating an object with a light pulse; (2) an imaging optical system for inputting and forming an image of the light pulse with which the object is irradiated from the light source and reflected by the object; and (3) an imaging element including a plurality of pixels each including a photodiode and arrayed on a light receiving surface for receiving the light pulse passed through the imaging optical system, and the method includes commonly applying, to the plurality of pixels, a control pattern in which a first logical value and a second logical value appear alternately in time from a light pulse output timing of the light source; accumulating, in each of the plurality of pixels, charges generated in the photodiode in a period in which the control pattern has the first logical value in a first charge accumulation portion; and acquiring a distance image of the object by acquiring, for each of the plurality of pixels, a distance to the object by a compressive sensing technique based on an amount of charges accumulated in the first charge accumulation portion when the control pattern is set to each of a plurality of control patterns.

### Advantageous Effects of Invention

According to the distance image acquisition apparatus and the distance image acquisition method of the embodiments, it is possible to easily acquire a distance image with high spatial resolution by the compressive sensing technique.

### BRIEF DESCRIPTION OF DRAWINGS

FIG. 1 is a diagram illustrating a configuration of a distance image acquisition apparatus 1.

FIG. 2 is a diagram illustrating a configuration of an imaging element 5.

FIG. 3 includes diagrams schematically illustrating a configuration of each pixel of the imaging element 5, and includes (a) a diagram illustrating a circuit configuration of the pixel, and (b) a diagram schematically illustrating a state in which, when a switch SW1 is in an OFF state and a switch SW2 is in an ON state, charges generated in a photodiode PD are transferred to a second charge accumulation portion C2.

FIG. 4 is a diagram illustrating a control pattern of a comparative example.

FIG. 5 is a diagram illustrating an example of a control pattern according to an embodiment.

FIG. 6 is a diagram illustrating another example of the control pattern according to the embodiment.

FIG. 7 is a diagram illustrating another example of the control pattern according to the embodiment.

FIG. 8 is a diagram illustrating another example of the control pattern according to the embodiment.

FIG. 9 is a diagram illustrating another example of the control pattern according to the embodiment.

FIG. 10 is a diagram illustrating another example of the control pattern according to the embodiment.

FIG. 11 is a graph showing a simulation result.

FIG. 12 is a graph showing the simulation result.

### DESCRIPTION OF EMBODIMENTS

Hereinafter, embodiments of a distance image acquisition apparatus and a distance image acquisition method will be described in detail with reference to the accompanying drawings. In the description of the drawings, the same elements will be denoted by the same reference signs, and redundant description will be omitted. The present invention is not limited to these examples.

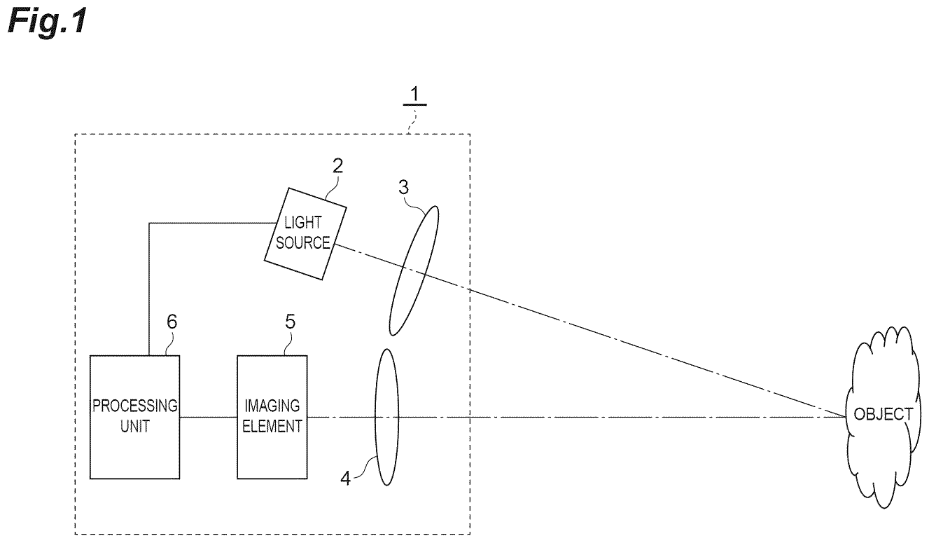

FIG. 1 is a diagram illustrating a configuration of a distance image acquisition apparatus 1. The distance image acquisition apparatus 1 is an apparatus for acquiring a distance image of an object by the TOF method, and includes a light source 2, an irradiation optical system 3, an imaging optical system 4, an imaging element 5, and a processing unit 6.

The light source 2 outputs a light pulse with which the object is to be irradiated. The light source 2 outputs the light pulse having a constant pulse width at a constant repetition frequency. The light source 2 is arbitrary as long as it can output the light pulse, and is, for example, a laser light source, a light emitting diode, or the like.

The irradiation optical system 3 is an optical system for irradiating the object with the light output from the light source 2. When the light output from the light source 2 is diverging light, the irradiation optical system 3 efficiently applies the light to the object.

The imaging optical system 4 inputs the light pulse with which the object is irradiated from the light source 2 through the irradiation optical system 3 and reflected by the object, and forms an image of the object on a light receiving surface of the imaging element 5 by the input light pulse.

The imaging element 5 receives the light pulse reflected by the object and passed through the imaging optical system 4 on the light receiving surface. A plurality of pixels are arrayed on the light receiving surface of the imaging element 5. Each of the plurality of pixels includes a photodiode for generating charges by receiving light, and a charge accumulation portion for accumulating the charges generated in the photodiode.

The processing unit 6 applies a control pattern to each of the plurality of pixels of the imaging element 5. The control pattern is a pattern for indicating a period in which the charges generated in the photodiode in each of the plurality of pixels are accumulated in the charge accumulation portion. The processing unit 6 acquires the distance image of the object based on an amount of charges generated in the photodiode of each of the plurality of pixels and accumulated in the charge accumulation portion.

The processing unit 6 may be a computer. The processing unit 6 includes a storage unit (for example, a hard disk drive, a RAM, a ROM, and the like) for storing the control pattern and the distance image, a display unit (for example, a liquid crystal display and the like) for displaying the control pattern and the distance image, an input unit (for example, a keyboard, a mouse, and the like) for receiving instructions for starting measurement and inputs of measurement conditions, and a control unit (for example, a CPU, a FPGA, and the like) for controlling an operation of the entire apparatus.

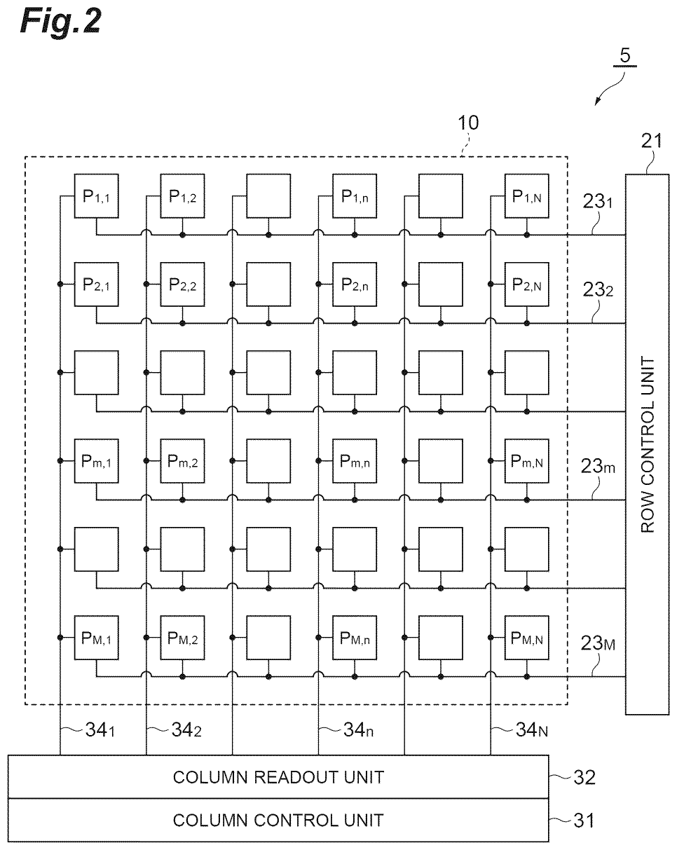

FIG. 2 is a diagram illustrating a configuration of the imaging element 5. The imaging element 5 includes a pixel array unit 10, a row control unit 21, a column control unit 31, and a column readout unit 32.

The pixel array unit 10 includes MN pixels P_{1,1} to P_{M,N} being arrayed two-dimensionally in M rows and N columns. The MN pixels P_{1,1} to P_{M,N} have a common configuration. The pixel P_{m,n} is located at an m-th row and an n-th column. The pixel P_{m,n} includes a photodiode for generating charges by receiving light, and one or a plurality of charge accumulation portions for accumulating the charges generated in the photodiode. In addition, each of M and N is an integer of 2 or more. m is an integer of 1 or more and M or less. n is an integer of 1 or more and N or less.

The row control unit 21 is coupled to the N pixels P_{m,1} to P_{m,N} of the m-th row by an m-th row control line 23ₘ. The row control unit 21 applies an m-th row control signal to the N pixels P_{m,1} to P_{m,N} of the m-th row via the m-th row control line 23ₘ. The row control unit 21 specifies the row in which the charges accumulated in the charge accumulation portion are to be output by the first to M-th row control signals.

The column readout unit 32 is coupled to the M pixels P_{1,n}, to P_{M,n}, of the n-th column by an n-th column output line 34ₙ. The column readout unit 32 inputs the charges accumulated in the charge accumulation portion of any pixel in the M pixels P_{1,n}, to P_{M,n} of the n-th column via the n-th column output line 34ₙ. The column readout unit 32 may include a charge amplifier for outputting a voltage value according to an amount of input charges, and an AD converter for outputting a digital value according to the voltage value output from the charge amplifier.

The column control unit 31 sequentially outputs the signal according to the amount of charges input to the column readout unit 32 via the n-th column output line 34ₙ from the column readout unit 32.

In the imaging element 5, the first to M-th rows are sequentially selected by the first to M-th row control lines 23₁ to 23_{M} output from the row control unit 21, and the charges accumulated in the charge accumulation portion in each of the N pixels P_{m,1} to P_{m,N} of the selected row are output to the first to N-th column output lines 34₁ to 34_{N} and input to the column readout unit 32. Further, by the column control unit 31, the signal according to the amount of charges input to the column readout unit 32 via the first to N-th column output lines 34₁ to 34_{N} is sequentially output from the column readout unit 32.

Further, in the imaging element 5, the control pattern is applied to the MN pixels P_{1,1} to P_{M,N}. The row control unit 21 may apply the control pattern, or another circuit may apply the control pattern.

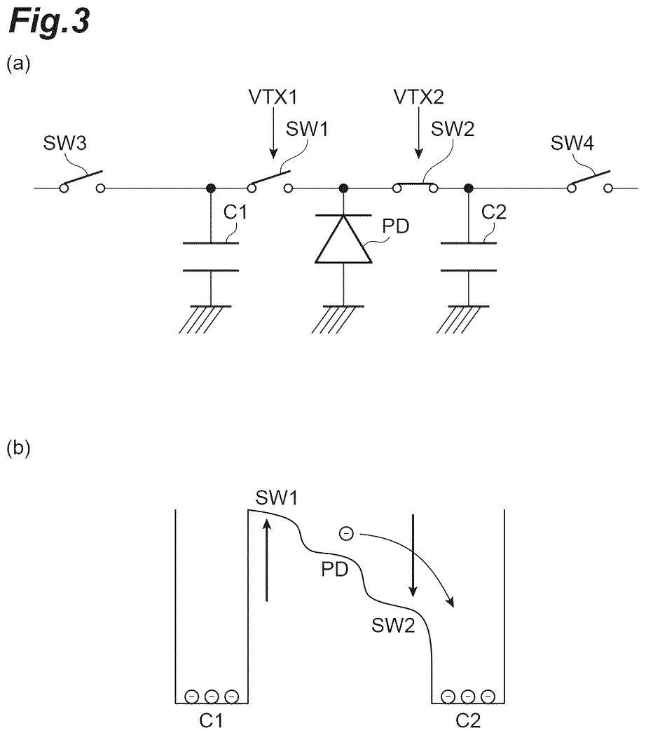

FIG. 3 includes diagrams schematically illustrating a configuration of each pixel of the imaging element 5. In this diagram, each pixel has the configuration including two charge accumulation portions.

The pixel includes a photodiode PD for generating the charges in response to light receiving, a first charge accumulation portion C1 and a second charge accumulation portion C2 for accumulating the charges, a switch SW1 for transferring the charges generated in the photodiode PD to the first charge accumulation portion C1, a switch SW2 for transferring the charges generated in the photodiode PD to the second charge accumulation portion C2, a switch SW3 for outputting the charges accumulated in the first charge accumulation portion C1 to the column output line, and a switch SW4 for outputting the charges accumulated in the second charge accumulation portion C2 to the column output line.

(a) in FIG. 3 illustrates a circuit configuration of the pixel. (b) in FIG. 3 schematically illustrates a state in which, when the switches SW1, SW3 and SW4 are in the OFF state and the switch SW2 is in the ON state, the charges generated in the photodiode PD are transferred to the second charge accumulation portion C2 via the switch SW2. When the charge transfer to the second charge accumulation portion C2 is completed, the switch SW2 becomes the OFF state and the switch SW4 becomes the ON state, and the charges accumulated in the second charge accumulation portion C2 are output to the column output line via the switch SW4 and are input to the column readout unit 32.

The number of charge accumulation portions may be one, or may be two or more. Any one of the plurality of charge accumulation portions may be used as a charge removal portion, or a charge removal portion may be separately provided. The charge removal portion is a portion for accumulating the charges generated in the photodiode in a period in which the charge accumulation is not indicated by the control pattern, and does not need to output the charges to the column output line. Further, each pixel includes a switch for initializing the charge accumulation in each of the charge accumulation portion and the charge removal portion.

The imaging element described with reference to FIG. 2 and FIG. 3 is described in Patent Document 2, and is sold as a product as described in Non Patent Document 1. The distance image acquisition apparatus 1 and the distance image acquisition method of the present embodiment use the light source, the optical system, and the imaging element as described above, and in addition, have one feature in the control pattern, and acquire the distance image of the object by the compressive sensing technique.

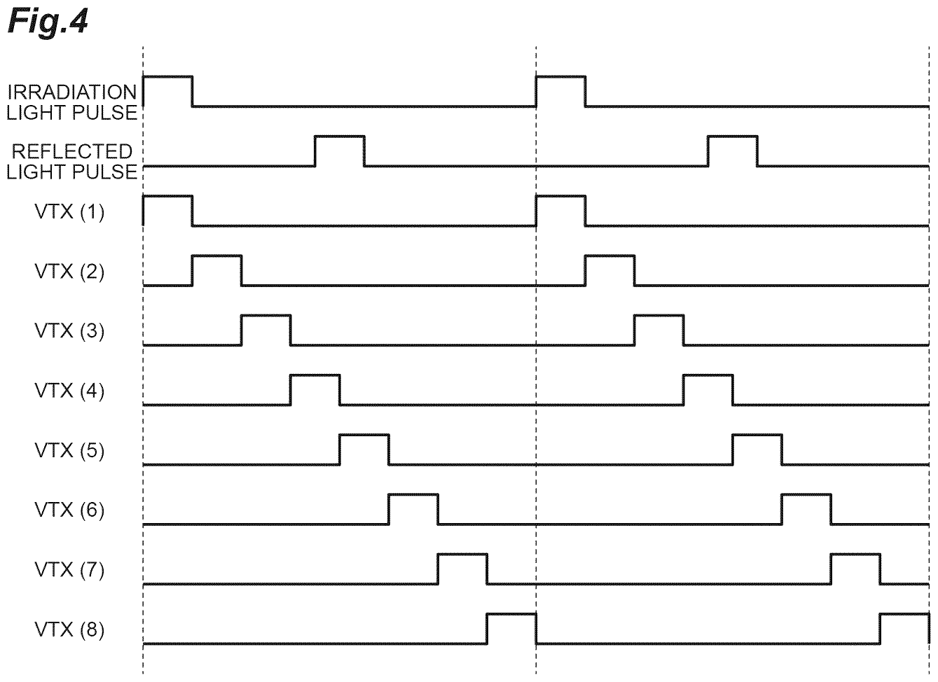

FIG. 4 is a diagram illustrating the control pattern of a comparative example. In this diagram, in order from the top, a waveform of an irradiation light pulse output from the light source, a waveform of a reflected light pulse reaching the imaging element, and the control patterns VTX(1) to VTX(8) for indicating the period in which the charges generated in the photodiode in each pixel are accumulated in the charge accumulation portion are illustrated. Although the waveform of the irradiation light pulse and the waveform of the reflected light pulse practically have noise and distortion, these are schematically illustrated by rectangles in this diagram (and in subsequent diagrams).

With respect to a light pulse output timing of the light source, a reflected light pulse arrival timing to each pixel of the imaging element has a time difference depending on a distance to a position corresponding to the pixel in the object. When the above time difference is detected, the distance to the position corresponding to the pixel in the object can be acquired. A phase shift method is used to detect the time difference.

In the phase shift method, a plurality of (eight in the diagram) control patterns VTX(1) to VTX(8) are prepared. When the light pulse output timing of the light source is set to a time 0 being a reference, and a pulse width of the irradiation light pulse is set to T, the control pattern VTX(k) becomes a logical value H in a period from a time (k−1)T to a time kT, and becomes a logical value L in the other periods. k is an integer of 1 or more and 8 or less. In the pixel to which the control pattern VTX(k) is applied, the charges generated in the photodiode in the period from the time (k−1)T to the time kT with the logical value H are selectively accumulated in the charge accumulation portion, and then, the charges accumulated in the charge accumulation portion are output from the pixel.

The time difference of the reflected light pulse arrival timing with respect to the irradiation light pulse output timing can be acquired based on the amount of charges accumulated in the charge accumulation portion of the pixel, when each of the control patterns VTX(1) to VTX(8) is applied to the pixel. In the example illustrated in the diagram, the charges are accumulated in the charge accumulation portion of the pixel when each of the control pattern VTX(4) and the control pattern VTX(5) is applied to the pixel, and thus, it can be determined that the time difference of the reflected light pulse arrival timing with respect to the irradiation light pulse output timing is within a range of 3T to 5T.

Further, the time difference of the reflected light pulse arrival timing with respect to the irradiation light pulse output timing is detected in more detail based on a ratio of the amounts of charges accumulated in the charge accumulation portion of the pixel when the control pattern VTX(4) and the control pattern VTX(5) are respectively applied to the pixel. Based on the time difference, the distance to the position corresponding to the pixel in the object can be acquired.

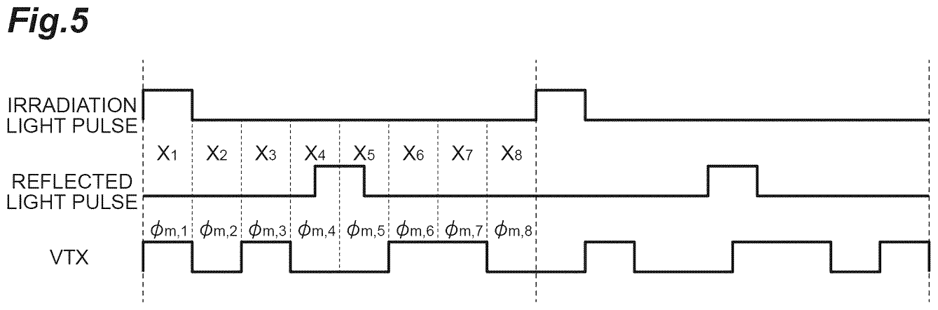

FIG. 5 is a diagram illustrating an example of the control pattern according to the present embodiment. In this diagram, in order from the top, the waveform of the irradiation light pulse output from the light source, the waveform of the reflected light pulse reaching the imaging element, and the control pattern VTX for indicating the period in which the charges generated in the photodiode in each pixel are accumulated in the charge accumulation portion are illustrated.

The control pattern VTX is a pattern in which a first logical value and a second logical value appear alternately in time from the light pulse output timing of the light source 2, and is commonly applied to the plurality of pixels of the imaging element 5. One of the first logical value and the second logical value is the logical value H, and the other is the logical value L.

In the comparative example (FIG. 4), there is only one period of the logical value H indicating the period of the charge transfer from the photodiode to the charge accumulation portion in each control pattern, and the plurality of control patterns in which the period of the logical value H is sequentially shifted by the time T are used.

On the other hand, in the present embodiment, in each control pattern, the period of the logical value H indicating the period of the charge transfer from the photodiode to the charge accumulation portion may be one period or a plurality of periods, and the plurality of control patterns in which the periods of the logical value H are different from each other are used. The plurality of control patterns used in the present embodiment may be set at random, or may be set based on a Hadamard matrix or the like.

As illustrated in the diagram, the reflected light pulse appears within a limited period after the light pulse output timing of the light source, and the reflected light does not exist in other time periods, and thus, the reflected light intensity as a function of time has sparsity. Therefore, by using the compressive sensing technique, the time from the irradiation light pulse output timing to the reflected light pulse arrival timing can be obtained, and the distance to the object can be acquired. Further, the number of control patterns required in the present embodiment may be smaller than the number of control patterns required in the comparative example.

In the distance image acquisition apparatus 1 of the present embodiment, the processing unit 6 acquires, for each of the plurality of pixels of the imaging element 5, the distance to the object by the compressive sensing technique based on the amount of charges accumulated in the charge accumulation portion when the control pattern is set to each of the plurality of control patterns. In each control pattern, a length of the period of each of the logical value H and the logical value L is preferably an integer multiple of a unit time. The unit time is a minimum unit of the period of each of the logical value H and the logical value L in each control pattern. In addition, the unit time may be equal to the pulse width T of the irradiation light pulse.

Hereinafter, the number of used control patterns is set to M, a vector of the signal value output from the column readout unit 32 according to the amount of charges accumulated in the pixel is set to y, a matrix representing the M control patterns is set to Φ, and a vector of temporal change of the reflected light intensity (intensity of the reflected light reaching the pixel) to be reconstructed is set to x. In this case, a relationship of the following Formula (1) holds therebetween.

$$[ Formula 1 ]$$

$$y = Φ x \qquad ( 1 )$$

The following Formula (2) represents the above Formula (1) by using each element yₘ of the column vector y, each element ϕ_{m,n} of the matrix Φ, and each element xₙ of the column vector x in Formula (1). yₘ is the signal value obtained by measurement using the m-th control pattern in the M control patterns. xₙ is the reflected light intensity of the n-th period in the N periods divided after the irradiation light pulse output timing. ϕ_{m,n} is the logical value indicating the charge accumulation in the n-th period in the m-th control pattern. m is an integer of 1 or more and M or less. n is an integer of 1 or more and N or less.

$$[ Formula 2 ]$$

$$( \begin{matrix}{y}_{1} \\ {y}_{2} \\ … \\ … \\ … \\ {y}_{M - 1} \\ {y}_{M}\end{matrix} ) = ( \begin{matrix}{ϕ}_{1 , 1} & … & {ϕ}_{1 , M} & … & {ϕ}_{1 , N} \\ {ϕ}_{2 , 1} & … & {ϕ}_{2 , M} & … & {ϕ}_{2 , N} \\ … & … & … & … & … \\ … & … & … & … & … \\ … & … & … & … & … \\ {ϕ}_{M - 1 , 1} & … & {ϕ}_{M - 1 , M} & … & {ϕ}_{M - 1 , N} \\ {ϕ}_{M , 1} & … & {ϕ}_{M , M} & … & {ϕ}_{M , N}\end{matrix} ) ( \begin{matrix}{x}_{1} \\ {x}_{2} \\ … \\ {x}_{M} \\ … \\ {x}_{N - 1} \\ {x}_{N}\end{matrix} ) \qquad ( 2 )$$

When M=N, and the inverse matrix of the matrix Φ exists, the temporal change x of the reflected light intensity is uniquely obtained. On the other hand, when M<N, the above Formula becomes the underdetermined system, and the temporal change x of the reflected light intensity cannot be mathematically solved.

However, even in the case of M<N, when the temporal change x of the reflected light intensity is sparse (or becomes sparse by linear transform such as Fourier transform), the temporal change x of the reflected light intensity can be reconstructed by the compressive sensing technique. Specifically, the temporal change x of the reflected light intensity can be reconstructed by solving the optimization problem represented by the following Formula (3). λ is a parameter representing an allowable value of an error.

$$[ Formula 3 ]$$

$$arg {min}_{x ∈ {R}^{N}} \frac{1}{2} {‖ Φ x - y ‖}_{2}^{2} + λ {‖ x ‖}_{1} \qquad ( 3 )$$

According to the present embodiment, the distance image can be acquired by the compressive sensing technique using the smaller number of control patterns than in the case of the comparative example. In the present embodiment, the common control pattern is applied to the plurality of pixels in the imaging element, and thus, compared with the invention disclosed in Patent Document 1, it is possible to acquire the distance image with high spatial resolution, simplify the configuration of the optical system to reduce costs, it is not necessary to perform processing for parallax correction, and further, it is possible to simplify the configuration for preparing the control pattern.

Not only the reflected light pulse but also the background light is incident on each pixel of the imaging element. In order to reduce the influence of the background light, the signal value obtained in the reflected light pulse measurement may be corrected by hardware or software, based on the amount of charges accumulated in the charge accumulation portion or the charge removal portion in a period in which only the background light is incident on the imaging element (a period in which the light pulse is not output from the light source before or after the reflected light pulse measurement, or a period in which the reflected light pulse is not incident on the imaging element even in the reflected light pulse measurement). Further, the signal value obtained at the time of the reflected light pulse measurement can also be corrected by preparing the matrix Φ in consideration of the background light intensity.

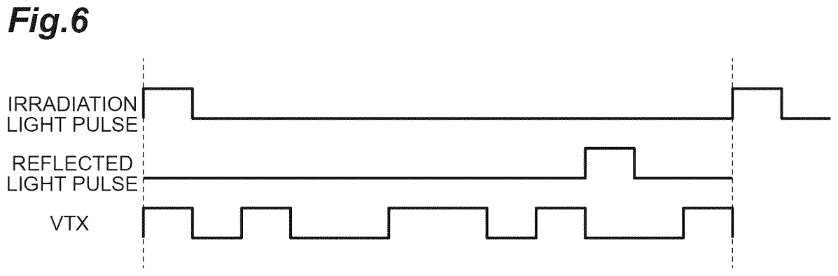

FIG. 6 is a diagram illustrating another example of the control pattern according to the present embodiment. In this diagram also, in order from the top, the waveform of the irradiation light pulse output from the light source, the waveform of the reflected light pulse reaching the imaging element, and the control pattern VTX for indicating the period in which the charges generated in the photodiode in each pixel are accumulated in the charge accumulation portion are illustrated.

As compared with the example illustrated in FIG. 5, in the example illustrated in FIG. 6, the time from the irradiation light pulse output timing to the reflected light pulse arrival timing exceeds the length of the control pattern VTX in FIG. 5. In this case, in the case of the comparative example illustrated in FIG. 4, it is necessary to increase the number of control patterns in order not to decrease temporal resolution. On the other hand, in the present embodiment, it is sufficient to lengthen each control pattern, and thus, it is possible to acquire the distance image with high temporal resolution without increasing the number of control patterns, or while suppressing an increase in the number of control patterns.

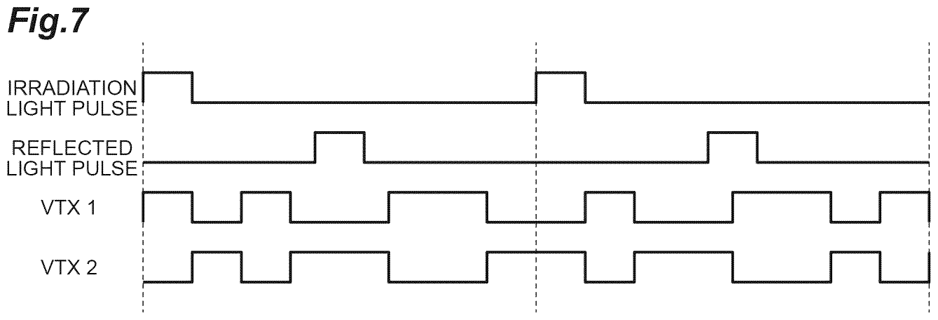

FIG. 7 is a diagram illustrating another example of the control pattern according to the present embodiment. In this diagram, in order from the top, the waveform of the irradiation light pulse output from the light source, the waveform of the reflected light pulse reaching the imaging element, and the control pattern VTX1 and the control pattern VTX2 each for indicating the period in which the charges generated in the photodiode in each pixel are accumulated in the charge accumulation portion are illustrated. The control pattern VTX2 is a pattern obtained by logically inverting the control pattern VTX1.

When the pixel includes the plurality of charge accumulation portions as illustrated in FIG. 3, the first charge accumulation portion can accumulate the charges generated in the photodiode in a period in which the control pattern VTX1 has the logical value H, and the second charge accumulation portion can accumulate the charges generated in the photodiode in a period in which the control pattern VTX2 has the logical value H (a period in which the control pattern VTX1 has the logical value L). Further, the processing unit can acquire, for each of the plurality of pixels, the distance to the object by the compressive sensing technique based on the amount of charges accumulated in the first charge accumulation portion and the amount of charges accumulated in the second charge accumulation portion when the control pattern is set to each of the plurality of control patterns.

In this example, the control pattern VTX2 is a pattern obtained by logically inverting the control pattern VTX1, and thus, the reflected light pulse measurement using both the control pattern VTX1 and the control pattern VTX2 can be performed substantially simultaneously. Therefore, the number of control patterns to be prepared can be reduced by half, and the time required for the entire measurement can be reduced by half. In addition, even when the sensitivities are different from each other for the charge accumulation in the first charge accumulation portion and the second charge accumulation portion, the difference of the sensitivities can be corrected.

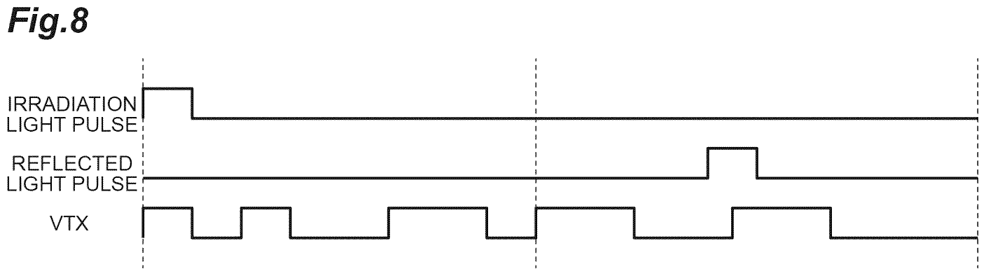

FIG. 8 is a diagram illustrating another example of the control pattern according to the present embodiment. In this diagram, in order from the top, the waveform of the irradiation light pulse output from the light source, the waveform of the reflected light pulse reaching the imaging element, and the control pattern VTX for indicating the period in which the charges generated in the photodiode in each pixel are accumulated in the charge accumulation portion are illustrated.

In this example, in the control pattern, the length of the period of each of the logical value H and the logical value L is set to the integer multiple of the unit time, and in addition, the unit time after a lapse of the predetermined period is set to be longer than the unit time in the predetermined period from the light pulse output timing of the light source. The unit time in the predetermined period from the light pulse output timing of the light source (for example, a period of 100 ns) may be set to be the same as the pulse width T (for example, 10 ns) of the irradiation light pulse, and the unit time after a lapse of the predetermined period may be set to 2T. The unit time may be changed in multiple stages.

In general, as the distance to the object is longer, the intensity of the reflected light pulse incident on the imaging element tends to be smaller, and further, even when temporal resolution of the distance measurement is low, it is allowed. In this example, when the distance is short, temporal resolution of the distance measurement can be increased by shortening the unit time. On the other hand, when the distance is long, it is possible to increase the light receiving amount of the reflected light pulse in the period of the unit time by increasing the unit time. Further, a range of the distance measurement can be expanded without increasing the number of times of measurement.

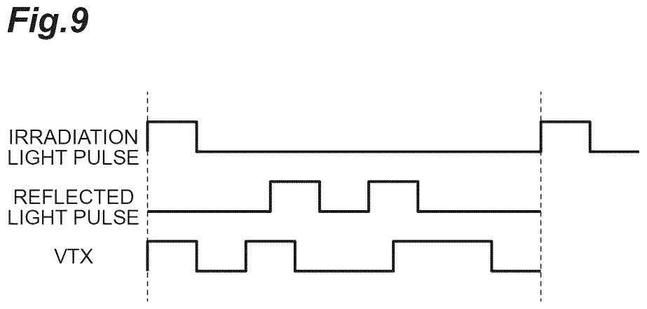

FIG. 9 is a diagram illustrating another example of the control pattern according to the present embodiment. In this diagram also, in order from the top, the waveform of the irradiation light pulse output from the light source, the waveform of the reflected light pulse reaching the imaging element, and the control pattern VTX for indicating the period in which the charges generated in the photodiode in each pixel are accumulated in the charge accumulation portion are illustrated.

In this example, a case in which a plurality of reflected light pulses reach the imaging element after the light pulse output timing of the light source is illustrated. As an example of the case in which the plurality of reflected light pulses reach the imaging element for the one irradiation light pulse as described above, there is a case in which the object includes a translucent object such as glass, and an object behind the translucent object. In this case, the light pulse reflected by the translucent object and the light pulse transmitted through the translucent object and reflected by the object behind may be incident on the imaging element.

Even in the above case also, when the temporal change x of the reflected light intensity is sparse (or becomes sparse by linear transform such as Fourier transform), the temporal change x of the reflected light intensity can be reconstructed by the compressive sensing technique using the small number of control patterns.

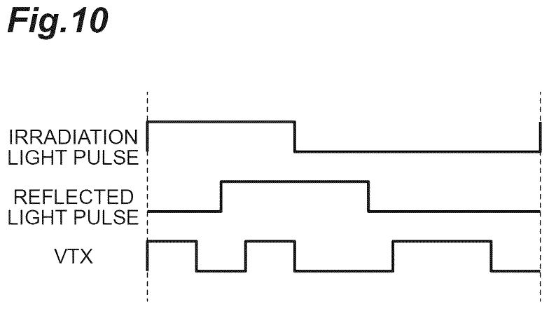

FIG. 10 is a diagram illustrating another example of the control pattern according to the present embodiment. In this diagram also, in order from the top, the waveform of the irradiation light pulse output from the light source, the waveform of the reflected light pulse reaching the imaging element, and the control pattern VTX for indicating the period in which the charges generated in the photodiode in each pixel are accumulated in the charge accumulation portion are illustrated.

In this example, the light pulse output from the light source has the pulse width longer than the unit time in the control pattern VTX. The pulse width of the output light pulse may be an integer multiple of the unit time in the control pattern VTX. Even in the above case also, the temporal change x of the reflected light intensity is sparse, or the time derivative of the temporal change x of the reflected light intensity is sparse, and thus, it is possible to apply the compressive sensing technique, and the distance image with high spatial resolution can be acquired. Further, the amount of charges accumulated in the charge accumulation portion increases in the measurement using each control pattern, and thus, the distance image having the good SN ratio can be acquired.

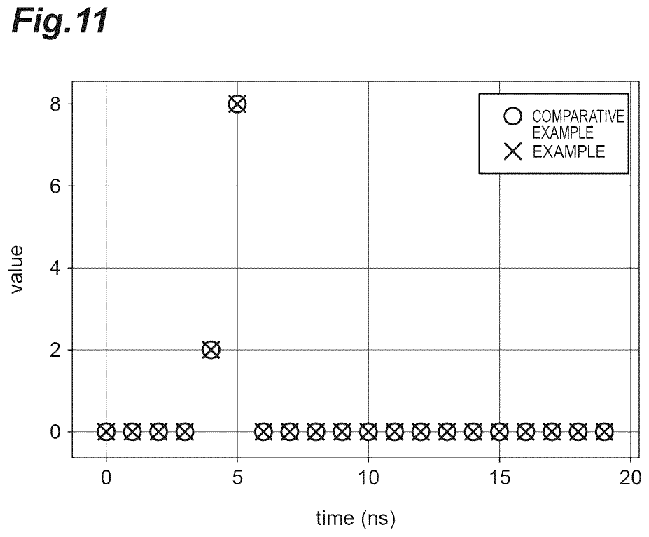

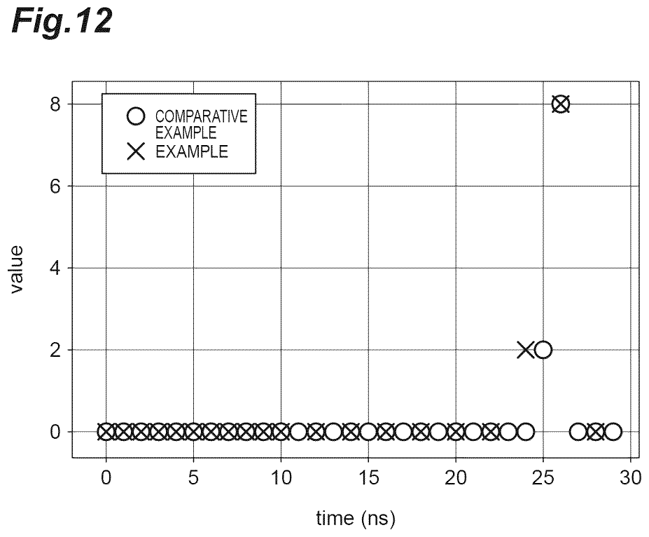

Next, simulation results will be described with reference to FIG. 11 and FIG. 12.

A graph of the simulation results illustrated in FIG. 11 shows the respective results of the comparative example using the control pattern illustrated in FIG. 4, and the example using the control pattern illustrated in FIG. 5. In this graph, the horizontal axis indicates the time when the light pulse output timing of the light source is set as the reference time 0, and the vertical axis indicates the intensity of the reflected light pulse for each unit time in the control pattern.

The pulse width of each of the irradiation light pulse and the reflected light pulse is set to 1 ns, and a period in which the reflected light pulse reaches the imaging element is set to a time period of 4.8 ns to 5.8 ns. The unit time being the minimum unit of the period of each of the logical value H and the logical value L in each control pattern is set to 1 ns which is the same as the pulse width of the light pulse. In the comparative example, 20 control patterns in which the period of the logical value H is sequentially shifted by 1 ns are used. In the example, 8 control patterns being set at random are used.

As shown in this diagram, in the example in which the compressive sensing technique is applied, although the number of used control patterns (8) is smaller than the number of control patterns (20) in the comparative example, the acquired distance is the same as that of the comparative example.

A graph of the simulation results illustrated in FIG. 12 shows the respective results of the comparative example using the control pattern illustrated in FIG. 4, and the example using the control pattern illustrated in FIG. 8. In this graph also, the horizontal axis indicates the time when the light pulse output timing of the light source is set as the reference time 0, and the vertical axis indicates the intensity of the reflected light pulse for each unit time in the control pattern.

The pulse width of each of the irradiation light pulse and the reflected light pulse is set to 1 ns, and a period in which the reflected light pulse reaches the imaging element is set to a time period of 25.8 ns to 26.8 ns. In the comparative example, the unit time in each control pattern is set to 1 ns which is the same as the pulse width of the light pulse, and 30 control patterns in which the period of the logical value H is sequentially shifted by 1 ns are used. In the example, the unit time in each control pattern is set to 1 ns in a period from a time 0 to a time 10 ns, and is set to 2 ns in a period from a time 10 ns to a time 30 ns, and 8 control patterns being set at random are used.

As shown in this diagram, in the example in which the compressive sensing technique is applied, although the number of used control patterns (8) is significantly smaller than the number of control patterns (30) in the comparative example, the acquired distance is substantially the same as that of the comparative example.

As described above, in the present embodiment, the control pattern is commonly applied to all the pixels on the light receiving surface of the imaging element, and the distance image is acquired by the TOF method and the compressive sensing technique. Therefore, the distance image with high temporal resolution can be acquired using the small number of control patterns. Further, in the present embodiment, the configuration of the optical system can be simplified and the cost can be reduced, it is not necessary to perform processing for parallax correction, and further, it is possible to simplify the configuration for preparing the control pattern.

The distance image acquisition apparatus and the distance image acquisition method are not limited to the embodiments and configuration examples described above, and various modifications are possible.

The distance image acquisition apparatus of the above embodiment is an apparatus for acquiring a distance image of an object by a time-of-flight method, and includes (1) a light source for irradiating an object with a light pulse; (2) an imaging optical system for inputting and forming an image of the light pulse with which the object is irradiated from the light source and reflected by the object; (3) an imaging element including a plurality of pixels each including a photodiode and arrayed on a light receiving surface for receiving the light pulse passed through the imaging optical system; and (4) a processing unit for commonly applying, to the plurality of pixels, a control pattern in which a first logical value and a second logical value appear alternately in time from a light pulse output timing of the light source, and acquiring a distance image of the object based on charges generated in the photodiode of each of the plurality of pixels, and each of the plurality of pixels includes a first charge accumulation portion for accumulating the charges generated in the photodiode in a period in which the control pattern has the first logical value, and the processing unit acquires, for each of the plurality of pixels, a distance to the object by a compressive sensing technique based on an amount of charges accumulated in the first charge accumulation portion when the control pattern is set to each of a plurality of control patterns.

In the above distance image acquisition apparatus, each of the plurality of pixels may include a second charge accumulation portion for accumulating the charges generated in the photodiode in a period in which the control pattern has the second logical value, and the processing unit may acquire, for each of the plurality of pixels, the distance to the object by the compressive sensing technique based on the amount of charges accumulated in the first charge accumulation portion and an amount of charges accumulated in the second charge accumulation portion when the control pattern is set to each of the plurality of control patterns.

In the above distance image acquisition apparatus, the processing unit may commonly apply, to the plurality of pixels, the control pattern in which a length of a period of each of the first logical value and the second logical value is an integer multiple of a unit time. Further, the processing unit may commonly apply, to the plurality of pixels, the control pattern in which the unit time after a lapse of a predetermined period is longer than the unit time in the predetermined period from the light pulse output timing of the light source. Further, the light source may irradiate the object with the light pulse having a pulse width longer than the unit time.

In the above distance image acquisition apparatus, the processing unit may perform correction based on an intensity of background light when acquiring, for each of the plurality of pixels, the distance to the object by the compressive sensing technique.

The distance image acquisition method of the above embodiment is a method for acquiring a distance image of an object by a time-of-flight method, and uses (1) a light source for irradiating an object with a light pulse; (2) an imaging optical system for inputting and forming an image of the light pulse with which the object is irradiated from the light source and reflected by the object; and (3) an imaging element including a plurality of pixels each including a photodiode and arrayed on a light receiving surface for receiving the light pulse passed through the imaging optical system, and the method includes commonly applying, to the plurality of pixels, a control pattern in which a first logical value and a second logical value appear alternately in time from a light pulse output timing of the light source; accumulating, in each of the plurality of pixels, charges generated in the photodiode in a period in which the control pattern has the first logical value in a first charge accumulation portion; and acquiring a distance image of the object by acquiring, for each of the plurality of pixels, a distance to the object by a compressive sensing technique based on an amount of charges accumulated in the first charge accumulation portion when the control pattern is set to each of a plurality of control patterns.

In the above distance image acquisition method, in each of the plurality of pixels, the charges generated in the photodiode in a period in which the control pattern has the second logical value may be accumulated in a second charge accumulation portion, and the distance image of the object may be acquired by acquiring, for each of the plurality of pixels, the distance to the object by the compressive sensing technique based on the amount of charges accumulated in the first charge accumulation portion and an amount of charges accumulated in the second charge accumulation portion when the control pattern is set to each of the plurality of control patterns.

In the above distance image acquisition method, the control pattern in which a length of a period of each of the first logical value and the second logical value is an integer multiple of a unit time may be commonly applied to the plurality of pixels. Further, the control pattern in which the unit time after a lapse of a predetermined period is longer than the unit time in the predetermined period from the light pulse output timing of the light source may be commonly applied to the plurality of pixels. Further, the light source may irradiate the object with the light pulse having a pulse width longer than the unit time.

In the above distance image acquisition method, correction based on an intensity of background light may be performed when acquiring, for each of the plurality of pixels, the distance to the object by the compressive sensing technique.

### INDUSTRIAL APPLICABILITY

The embodiments can be used as a distance image acquisition apparatus and a distance image acquisition method capable of easily acquiring a distance image with high spatial resolution by the compressive sensing technique.

### REFERENCE SIGNS LIST

1-distance image acquisition apparatus, 2-light source, 3-irradiation optical system, 4-imaging optical system, 5-imaging element, 6-processing unit, 10-pixel array unit, 21-row control unit, 23-row control line, 31-column control unit, 32-column readout unit, 34-column output line, P_{1,1}-P_{M,N}-pixel.

1: A distance image acquisition apparatus for acquiring a distance image of an object by a time-of-flight method, the apparatus comprising:
a light source configured to irradiate an object with a light pulse;
an imaging optical system configured to input and form an image of the light pulse with which the object is irradiated from the light source and reflected by the object;
an imaging element including a plurality of pixels each including a photodiode and arrayed on a light receiving surface configured to receive the light pulse passed through the imaging optical system; and
a processor configured to commonly apply, to the plurality of pixels, a control pattern in which a first logical value and a second logical value appear alternately in time from a light pulse output timing of the light source, and acquire a distance image of the object based on charges generated in the photodiode of each of the plurality of pixels, wherein
each of the plurality of pixels includes a first charge accumulation portion configured to accumulate the charges generated in the photodiode in a period in which the control pattern has the first logical value, and
the processor is configured to acquire, for each of the plurality of pixels, a distance to the object by a compressive sensing technique based on an amount of charges accumulated in the first charge accumulation portion when the control pattern is set to each of a plurality of control patterns.

2: The distance image acquisition apparatus according to claim 1, wherein each of the plurality of pixels includes a second charge accumulation portion configured to accumulate the charges generated in the photodiode in a period in which the control pattern has the second logical value, and
the processor is configured to acquire, for each of the plurality of pixels, the distance to the object by the compressive sensing technique based on the amount of charges accumulated in the first charge accumulation portion and an amount of charges accumulated in the second charge accumulation portion when the control pattern is set to each of the plurality of control patterns.

3: The distance image acquisition apparatus according to claim 1, wherein the processor is configured to commonly apply, to the plurality of pixels, the control pattern in which a length of a period of each of the first logical value and the second logical value is an integer multiple of a unit time.

4: The distance image acquisition apparatus according to claim 3, wherein the processor is configured to commonly apply, to the plurality of pixels, the control pattern in which the unit time after a lapse of a predetermined period is longer than the unit time in the predetermined period from the light pulse output timing of the light source.

5: The distance image acquisition apparatus according to claim 3, wherein the light source is configured to irradiate the object with the light pulse having a pulse width longer than the unit time.

6: The distance image acquisition apparatus according to claim 1, wherein the processor is configured to perform correction based on an intensity of background light when acquiring, for each of the plurality of pixels, the distance to the object by the compressive sensing technique.

7: A distance image acquisition method for acquiring a distance image of an object by a time-of-flight method, the method using:
a light source configured to irradiate an object with a light pulse;
an imaging optical system configured to input and form an image of the light pulse with which the object is irradiated from the light source and reflected by the object; and
an imaging element including a plurality of pixels each including a photodiode and arrayed on a light receiving surface configured to receive the light pulse passed through the imaging optical system, wherein
the method comprises:
commonly applying, to the plurality of pixels, a control pattern in which a first logical value and a second logical value appear alternately in time from a light pulse output timing of the light source;
accumulating, in each of the plurality of pixels, charges generated in the photodiode in a period in which the control pattern has the first logical value in a first charge accumulation portion; and
acquiring a distance image of the object by acquiring, for each of the plurality of pixels, a distance to the object by a compressive sensing technique based on an amount of charges accumulated in the first charge accumulation portion when the control pattern is set to each of a plurality of control patterns.

8: The distance image acquisition method according to claim 7, wherein, in each of the plurality of pixels, the charges generated in the photodiode in a period in which the control pattern has the second logical value are accumulated in a second charge accumulation portion, and
the distance image of the object is acquired by acquiring, for each of the plurality of pixels, the distance to the object by the compressive sensing technique based on the amount of charges accumulated in the first charge accumulation portion and an amount of charges accumulated in the second charge accumulation portion when the control pattern is set to each of the plurality of control patterns.

9: The distance image acquisition method according to claim 7, wherein the control pattern in which a length of a period of each of the first logical value and the second logical value is an integer multiple of a unit time is commonly applied to the plurality of pixels.

10: The distance image acquisition method according to claim 9, wherein the control pattern in which the unit time after a lapse of a predetermined period is longer than the unit time in the predetermined period from the light pulse output timing of the light source is commonly applied to the plurality of pixels.

11: The distance image acquisition method according to claim 9, wherein the light source is configured to irradiate the object with the light pulse having a pulse width longer than the unit time.

12: The distance image acquisition method according to claim 7, wherein correction based on an intensity of background light is performed when acquiring, for each of the plurality of pixels, the distance to the object by the compressive sensing technique.
